(19) United States
(12) Patent Application Publication
(10) Pub. No.: US 2014/0229066 A1
(43) Pub. Date: Aug. 14, 2014

(54) ELECTRONIC CONTROL DEVICE FOR ELECTRIC POWER STEERING APPARATUS

(71) Applicant: Honda elesys Co., Ltd., Yokohama-shi (JP)

(72) Inventor: Kazuki Harada, Yokohama-shi (JP)

(73) Assignee: Honda elesys Co., Ltd., Yokohama-shi (JP)

(21) Appl. No.: 14/179,917

(22) Filed: Feb. 13, 2014

(30) Foreign Application Priority Data
Feb. 14, 2013 (JP) 2013-026472

(51) Int. Cl. B62D 5/04

(52) U.S. Cl. CPC B62D 5/0463
USPC 701/41

(57) ABSTRACT

An electronic control device for an electric power steering apparatus includes a power relay connected between a positive electrode of an on-vehicle power supply and a first line connected to the positive electrode of the on-vehicle power supply, a capacitive element connected between the first line and a second line connected to a negative electrode of the on-vehicle power supply, and a control section configured to switch ON and OFF states of the power relay to thereby perform pre-charging of the capacitive element.

### FIELD OF THE INVENTION

The present invention relates to an electronic control device for an electric power steering apparatus configured to assist a steering torque produced by a steering wheel with an assist torque generated by a brushless DC motor, for example.

### BACKGROUND OF THE INVENTION

Brushless DC motors are heavily used in various devices mounted in a motor vehicle. Recently, research and development on an electric power steering (EPS) apparatus has been advanced in order to reduce the load on a vehicle driver. In the EPS apparatus, a steering assist torque generated by a brushless DC motor is supplied to assist a steering torque produced by a steering wheel.

FIG. 6 hereof shows an internal configuration of an electronic control unit (ECU) 200 conventionally used as a computer for the EPS apparatus. The ECU 200 for the EPS apparatus will be referred to, for brevity, as the “ECU for EPS”. As shown in FIG. 6, the ECU 200 for EPS is comprised of a power board 202 electrically connected with a brushless DC motor 201 having a three-phase stator winding, and a control board 203 having a built-in microcomputer for controlling the power board 202. The power board 202 has a three-phase bridge circuit mounted thereon, the bridge circuit being composed of six metal oxide semiconductor field-effect transistors (MOS FETs). In FIG. 6, reference sign B+ denotes a potential of a positive electrode of an on-vehicle power supply 204, such as a battery mounted on a vehicle, and reference sign B− denotes a potential of a negative electrode of the on-vehicle power supply. The B− may be grounded to a vehicle body. The microcomputer mounted on the control board 203 drives the three-phase bridge circuit to supply an electric current to each coil of the three-phase stator winding of the brushless DC motor 201.

With the ECU 200 thus constructed, when short-circuiting occurs at any one of the FETs constituting the three-phase bridge circuit, a relay connected in series with each phase of the stator winding operates to shut off a current for failsafe. The current supplied from the three-phase bridge circuit to the brushless DC motor 201 is thus forcibly shut off. At least one electronic capacitor 205 is connected between a positive power line connected to the B+ and a negative power line connected to the B− so as to smoothen a supply voltage (a potential difference between the positive electrode potential B+ and the negative electrode potential B−) of the DC power supply. A relay 206 for cutting off power from the on-vehicle power supply 204 is connected to the positive power supply line B+ via a non-illustrated noise removing power coil. When the relay 206 operates, the three-phase bridge circuit is separated from the on-vehicle power supply 204 so that the respective FETs constituting the three-phase bridge circuit are protected from an overcurrent state.

The ECU 200 for EPS may encounter a problem that due to a large current (inrush current indicated by the arrow shown in FIG. 6) flowing into the electrolytic capacitor 205 at a start of turn-on operation of the relay 206, short-circuiting of the electrolytic capacitor 205 occurs to thereby cause fusion welding of a contact of the relay 206. To deal with this problem, the control board 203 is provided with a pre-charging circuit 207 having a charging resistor. The pre-charging circuit 207 is connected in parallel to the positive power line B+. Conventionally, at a first stage of motor start-up operation, the microcomputer turns on the pre-charging circuit 207 whereupon the electrolytic capacitor 205 is charged for a predetermined time period with a small current that has been suppressed by the charging resistor. Then, the pre-charging circuit 27 is turned off and, subsequently, the relay 206 is switched to an ON state. Electric components including the relay 206 are thus protected from any inconveniences caused by the rush current.

The mechanical relay operable via a mechanical contact can be replaced by a semiconductor relay composed of an MOSFET, as disclosed in International Patent Application Laid-open Publication (WO-A) No. WO 2010/007672 A1. The semiconductor relay is provided between a positive-electrode-side DC terminal of a three-phase bridge circuit and an on-vehicle power supply. When an abnormality occurs at any one of field-effect transistors (FETs) of the three-phase bridge circuit, an FET driving circuit operates, under the control of a microcomputer, to stop outputting of a gate drive signal to the semiconductor relay connected between an AC output terminal of the three-phase bridge circuit and a coil in each phase of the stator winding of a brushless DC motor. The three-phase bridge circuit is separated from the on-vehicle power supply and its operation is stopped. At the same time, the stator winding of the brushless DC motor is separated from the three-phase bridge circuit. The stator winding is, therefore, free from the danger of short-circuiting which may otherwise occur when the FET has failed. With this arrangement, it is possible to avoid an occurrence of abnormal state where due to a braking force generated by the brushless DC motor, an operation to steer the steering wheel in a desired direction is difficult to achieve.

According to WO 2010/007672 A1, a semiconductor relay is used in place of the mechanical relay to cut off or break the flow of current between positive and negative power lines. As a result, fusion welding of a mechanical relay, which has conventionally occurred due to an inrush current flowing into the electrolytic capacitor, does not take place. However, an inrush current generated when the relay is turned on has not been taken into consideration and, hence, there is still a problem that an MOSFET forming the semiconductor relay can be broken due to a closed circuit formed between the on-vehicle power supply such as a battery and the electrolytic capacitor. To avoid this problem, a pre-charging circuit provided exclusively for the electrolytic capacitor is still required. However, such a special pre-charging circuit will hinder downsizing and cost-reduction of an electronic control unit for electric power steering apparatus.

### SUMMARY OF THE INVENTION

It is, therefore, an object of the present invention to provide an electronic control device for an electric power steering apparatus, which is capable of achieving downsizing and cost-reduction regardless of whether a mechanical relay is used or a semiconductor relay is used, in order to cut off or break the flow of current between positive and negative power lines.

According to the present invention, there is provided an electronic control device for an electric power steering apparatus, comprising: a first line connected to a positive electrode of an on-vehicle power supply; a second line connected to a negative electrode of the on-vehicle power supply; a power relay connected between the positive electrode of the on-vehicle power supply and the first line; a capacitive element connected between the first line and the second line; and a control section configured to switch ON and OFF states of the power relay to thereby perform pre-charging of the capacitive element.

The control section, which is configured to switch ON and OFF states of the power relay to thereby perform pre-charging of the capacitive element, obviates the need for a separate pre-charging circuit. The electronic control device equipped with such control section is compact in size and can be constructed with reduced cost.

Preferably, the control section measures a voltage across the capacitive element and, when a voltage value equal to or higher than a predetermined threshold voltage set to be lower than a supply voltage of the on-vehicle power supply is detected, the control section continues the ON state of the power relay to thereby start a motor of the electric power steering apparatus. The control section is, therefore, able to detect an abnormality of the capacitive element without requiring a separate charging circuit.

In one preferred form of the present invention, the electronic control device further comprises: a semiconductor driving circuit including a gate resistor; and a power coil connected to the first line, wherein the power relay comprises a semiconductor relay having a drain terminal connected to the power coil, the semiconductor relay being driven when a voltage equal to or higher than a predetermined threshold voltage set to be lower than a supply voltage of the on-vehicle power supply is applied via the gate resistor to the semiconductor relay. The power relay constituted by the semiconductor relay is free from a problem that may occur when a mechanical contact undergoes fusion welding due to an inrush current flowing into the capacitive element.

In another preferred form of the present invention, the electronic control device further comprises: a semiconductor driving circuit including a gate resistor; and a power coil connected to the first line, wherein the power relay includes: a first semiconductor relay having a drain terminal connected to the power coil, the first semiconductor relay being driven when a voltage equal to or higher than a predetermined threshold voltage set to be lower than a supply voltage of the on-vehicle power supply is applied via the gate resistor to the first semiconductor relay; and a second semiconductor relay having a source terminal connected in common with a source terminal of the first semiconductor relay and a drain terminal connected with a node located in the proximity of the capacitive element, and wherein the control section performs ON/OFF drive control of the first semiconductor relay via pulse-width modulation using a voltage obtained between a connection node between the power coil and the drain terminal of the first semiconductor relay and the second line. By virtue of the second semiconductor relay connected in series with the first semiconductor relay to thereby form the power relay, structural components including the first semiconductor relay can be protected from short-circuiting which may occur when the capacitive element is reversely connected. Furthermore, the ON/OFF drive control of the first semiconductor relay, which is performed via pulse-width modulation (PWM) using the voltage obtained between the node between the power coil and the drain terminal of the first semiconductor relay and the second line, can suppress a surge voltage resulting from a current applied to the power coil when the first semiconductor relay is turned on by the PWM control.

Preferably, the control section drives the semiconductor relay in such a manner that switching of the ON and OFF states of the semiconductor relay is repeatedly performed at a first duty ratio via pulse-width modulation for a first predetermined time period, then abnormality of the capacitive element is determined on the basis of a voltage value measured across the capacitive element while the OFF state of the semiconductor relay is continued for a second time period equal to or longer than the first time period. This arrangement ensures that the voltage value across the capacitive element can be measured without a separate pre-charging circuit, and abnormality determination of the capacitive element is possible to perform.

It is preferable that when the capacitive element is determined to be in an abnormal condition, the control section drives the semiconductor relay at a second duty ratio set to be smaller than the first duty ratio for a third time period shorter than the first time period. By thus setting the duty ratio and drive period, it is possible to suppress an overcurrent state of the semiconductor relay.

### BRIEF DESCRIPTION OF THE DRAWINGS

A preferred structural embodiment of the present invention will be described in detail herein below, by way of example only, with reference to the accompanying sheets of drawings, in which:

FIG. 1 is a diagrammatical view showing a general configuration of a vehicular electric power steering apparatus equipped with an electronic control device according to a preferred embodiment of the present invention;

FIG. 2 is a block diagram showing a general configuration of the electronic control device for the vehicular electric power steering apparatus;

FIG. 3 is a block diagram showing a main part of the electronic control device;

FIG. 4 is a flowchart showing a sequential operation of the electronic control device;

FIG. 5 is a timing chart illustrative of the operation of the electronic control device; and

FIG. 6 is a block diagram showing a general configuration of a conventional electronic control device for an electric power steering apparatus.

### DESCRIPTION OF THE PREFERRED EMBODIMENTS

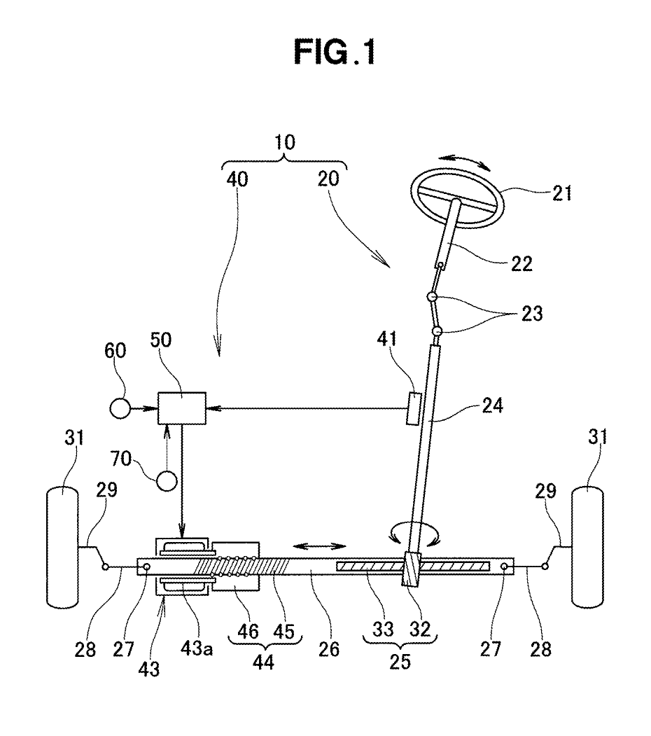

Referring now to the drawings and FIG. 1 is particular, there is shown an electric power steering apparatus 10 equipped with an electronic control device 50 embodying the present invention. The electric power steering apparatus 10 generally comprises a steering system 20 extending from a vehicle steering wheel 21 to steerable road wheels (in the illustrated embodiment, left and right front road wheels) 31, 31 of the vehicle, and a steering torque assist mechanism 40 for supplying steering assist torque to the steering system 20.

In the steering system 20, a pinion shaft 24 is coupled to the steering wheel 21 via a steering shaft 22 and universal joints 23, and a rack shaft 26 is coupled to the pinion shaft 24 via a rack-and-pinion mechanism 25. Further, the left and right steerable road wheels 31 are coupled to opposite ends of the rack shaft 26 via ball joints 27, left and right tie rods 28, and knuckle arms 29. The rack-and-pinion mechanism 25 includes a pinion 32 formed on the pinion shaft 24 and a rack 33 formed on the rack shaft 26.

With the steering system 20 thus arranged, when a human operator or driver of the vehicle operates the steering wheel 21, steering torque is delivered from the steering wheel 21 to the left and right steerable road wheels 31 via the rack-and-pinion mechanism 25, rack shaft 26, left and right tie rods 28 etc. and thereby steers the road wheels 31.

The steering torque assist mechanism 40 includes a steering torque sensor 41, a brushless DC motor 43 (motor for the electric power steering apparatus), a power transmitting mechanism 44, the electronic control device 50, a vehicle speed sensor 60, and a rotational angle sensor 70. The torque sensor 41 is configured to detect steering torque applied by the driver to the steering system 20 through operation of the steering wheel 21. The vehicle speed sensor 60 is configured to detect a vehicle speed. The rotational angle sensor 70 is configured to detect a rotational angle of the brushless DC motor 43. The torque transmission mechanism 44 is constituted by a ball screw, for example.

With the steering torque assist mechanism 40 thus arranged, the electronic control device 50 generates a control signal on the basis of steering torque detected by the steering torque sensor 41, the brushless DC motor 43 generates steering assist torque corresponding to the driver-applied steering torque on the basis of the control signal, and the torque transmission mechanism 44 transmits the motor-generated steering assist torque from the motor 43 to the rack shaft 26. More specifically, additional to the steering torque, a vehicle speed detected by the vehicle speed sensor and a rotational angle of the brushless DC motor 43 detected by the rotational angle sensor 70 are also taken into consideration when the electronic control device 50 generates the control signal. The electronic control device 50 of the type concerned is generally called “electronic control unit (ECU)” and will be hereinafter referred to as “ECU”.

The brushless DC motor 43 comprises a multi-phase brushless DC motor, such as three-phase DC brushless motor. In the following description, a three-phase DC brushless motor will be described as exemplifying the brushless DC motor 43. The brushless DC motor 43 has a motor shaft 43a which is constituted by a hollow shaft loosely fitted around a longitudinal portion of the rack shaft 26. The ball screw forming the torque transmitting mechanism 44 is constituted by a screw part 45 formed on that part of the rack shaft 26 devoid of the rack 33, a nut 46 assembled with the screw part 45, and a multiplicity of balls (not designated) interposed between the screw part 45 and the nut 46. The nut 46 is directly connected to the motor shaft 43a. The torque transmitting mechanism 44 may be so constructed as to transmit assist torque generated by the brushless DC motor 43 to the pinion shaft 24.

In the electric power steering apparatus 10, the steerable road wheels 31, 31 are steered by a combined torque which is a combination of a steering torque transmitted from the steering wheel 21 to the rack shaft 26 and an assist torque generated by the brushless DC motor 43.

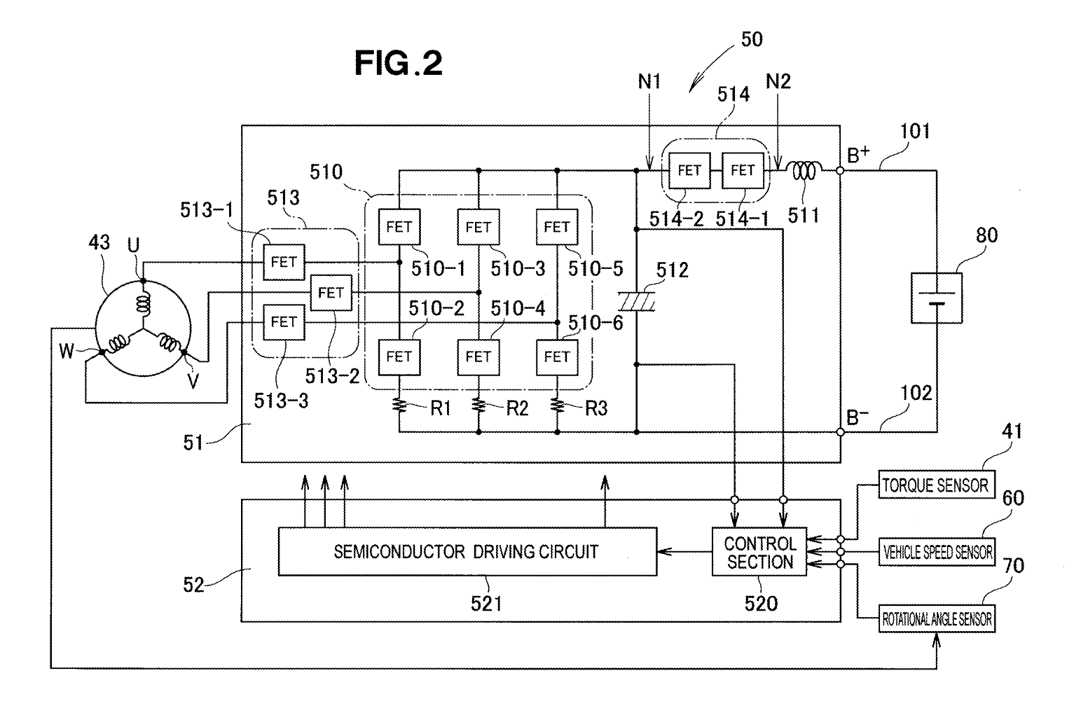

FIG. 2 is a block diagram showing an internal configuration of the ECU 50 for the electric power steering apparatus 10 shown in FIG. 1. As shown in FIG. 2, the ECU 50 includes a power board 51 and a control board 52. A positive-electrode potential B+ of an on-vehicle power supply 80 and a negative-electrode potential B− of the on-vehicle power supply 80 are supplied to the power board 51, respectively, through a positive power line (first line) 101 connected to a positive-electrode terminal of the on-vehicle power supply 80 and a negative power line (second line) 102 connected to a negative-electrode terminal of the on-vehicle power supply 80. The power board 51 is electrically connected to the brushless DC motor 43 via a U-phase terminal U, a V-phase terminal V and a W-phase terminal W of the brushless DC motor 43.

The power board 51 has mounted thereon a three-phase bridge circuit 510 composed of six semiconductor switching elements 510-1 to 510-6, a power coil 511 for removing noise, at least one electrolytic capacitor (capacitive element) 512 for smoothing supply voltage, a power relay 513 composed of three field-effects transistors (FETs) 513-1, 513-2 and 513-3 for fail-safe, and a power relay 514 composed of two field-effect transistors (FETs) 514-1 and 514-2. The three-phase bridge circuit 510 includes six semiconductor switching elements 510-1 to 510-6 and is connected to the positive and negative power lines 101, 102 in parallel relation to the electrolytic capacitor 512. The semiconductor switching elements 510-1 to 510-6 in the illustrated embodiment are formed of field-effect transistors (FETs). The three-phase bridge circuit 510 may be formed of a plurality of switching transistors, such as insulator gate bipolar transistors (IGBTs) in place of the FETs.

The semiconductor switching elements (FETs) 510-1 and 510-2 are connected in series between the positive power line 101 and the negative power line 102 and generate a U-phase current flowing through a U-phase of the brushless DC motor 43. As a current sensor for detecting the U-phase current, a shunt resistor R1 is provided between the semiconductor switching element (FET) 510-2 and the negative power line 102. Furthermore, as a power relay that can cut off or break the U-phase current, a field-effect transistor (FET) 513-1 is provided between a connection node between the semiconductor switching elements (FETs) 510-1 and 510-2 and the U-phase terminal U of the three-phase brushless DC motor 43.

The semiconductor switching elements (FETs) 510-3 and 510-4 are connected in series between the positive power line 101 and the negative power line 102 and generate a V-phase current flowing through a V-phase of the brushless DC motor 43. As a current sensor for detecting the V-phase current, a shunt resistor R2 is provided between the semiconductor switching element (FET) 510-4 and the negative power line 102. Furthermore, as a power relay that can cut off or break the V-phase current, a field-effect transistor (FET) 513-2 is provided between a connection node between the semiconductor switching elements (FETs) 510-3 and 510-4 and the V-phase terminal V of the three-phase brushless DC motor 43.

The semiconductor switching elements (FETs) 510-5 and 510-6 are connected in series between the positive power line 101 and the negative power line 102 and generate a W-phase current flowing through a W-phase of the brushless DC motor 43. As a current sensor for detecting the W-phase current, a shunt resistor R3 is provided between the semiconductor switching element (FET) 510-6 and the negative power line 102. Furthermore, as a power relay that can cut off or break the W-phase current, a field-effect transistor (FET) 153-3 is provided between a connection node between the semiconductor switching elements (FETs) 510-5 and 510-6 and the W-phase terminal W of the three-phase brushless DC motor 43.

As described above, the three-phase bridge circuit 510 is able to supply a U-phase current, a V-phase current and a W-phase current to the three-phase brushless DC motor 43 as drive signals, and the electrolytic capacitor 512 is able to smoothen a power voltage (an electric potential difference between the positive-electrode potential B+ and the negative-electrode potential B−) based on which the drive signals are generated. The semiconductor switching elements (FETs) 510-1 to 510-6 are electrically connected to the power relays (FETs) 514-1 and 514-2. The power relay (FET) 514-1 is operable to cut off or break the supply of electric power from the on-vehicle power supply 80, and the power relay (FET) 154-2 is operable to prevent reverse connection of the electrolytic capacitor 512.

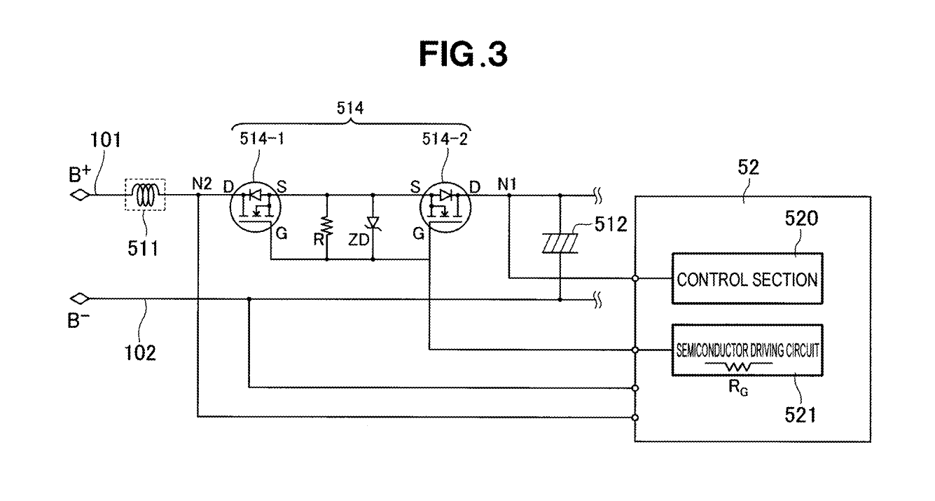

FIG. 3 shows a configuration of a circuit including the power relays 514-1 and 514-2 shown in FIG. 2 and peripheral parts thereof. As shown in FIG. 3, the power relay 514-1 is formed of a p-channel metal oxide semiconductor field-effect transistor (p-ch MOSFET), and the power relay 514-2 is formed of an n-channel metal oxide semiconductor field-effect transistor (n-ch MOSFET). The power relays 514-1 and 514-2 are connected in series and connected with the positive power line 101 at a position downstream of the noise-removing power coil 511 as viewed from the on-vehicle power supply. The power relay 514-1 is used as a fail-safe relay for cutting off or breaking the flow of current. The power relay 514-2 is used as a fail-safe relay for preventing reverse connection of the electrolytic capacitor 512.

The semiconductor power relays 514-1 and 514-2 have source terminals S mutually connected in common and also have gate G terminals mutually connected in common. A drain terminal D of the semiconductor power relay 514-1 is connected to a node N2 to which the power coil 101 is connected. A drain terminal D of the semiconductor power relay 514-2 is connected to a node N1 located in proximity to the electrolytic capacitor 512. A resistor R and a Zener diode ZD are connected in parallel between the commonly connected source terminals of the semiconductor power relays 514-1, 514-2 and the commonly connected gate terminals of the semiconductor power relays 514-1, 514-2, so that a predetermined voltage equal to or higher than the supply voltage of the on-vehicle power supply 80 is applied to the semiconductor power relays 514-1 and 514-2 via the gate resistor R_{G} included in the semiconductor driving circuit 521. The Zener diode ZD is a unidirectional Zener diode having an anode terminal connected to the commonly connected source terminals of the semiconductor power relays 514-1, 514-2 and a cathode terminal connected to the commonly connected gate terminals of the semiconductor power relays 514-1, 514-2.

As shown in FIG. 2, the control board 52 has a control section 520 and the semiconductor driving circuit 521 mounted thereon. The control section 520 has a built-on microcomputer. Under the control of the control section 520, the semiconductor driving circuit 521 drives the semiconductor switching elements (FETs) 510-1 to 510-6, the semiconductor power relays (FETs) 513-1 to 513-3, and the semiconductor power relays (FETs) 514-1 and 514-2. The control board 52 is supplied with the positive-electrode potential B+ and the negative-electrode potential B− through the positive power line 101 and the negative power line 102, respectively, connected to the positive-electrode terminal and the negative-electrode terminal of the on-vehicle power supply 80. Furthermore, the control board 52 is also connected via sensor input terminals (not designated) to the torque sensor 41, the vehicle speed sensor 60, and the rotational angle sensor 70. A steering torque, a vehicle speed, and a rotational angle of the brushless DC motor 43, that are detected respectively by the torque sensor 41, the vehicle speed sensor 60, and the rotational angle sensor 70, are used when the control section 520 generates a control signal for controlling the electric power steering apparatus 10 as described above with reference to FIG. 1.

The control section 520 operates to switch ON and OFF states of the semiconductor power relay 514-1 to perform pre-charging of the electrolytic capacitor 512. Furthermore, the control section 520 also operates to measure a voltage Vc across the electrolytic capacitor 512 and, when a voltage value equal to or higher than a threshold voltage Vth set to be lower than the supply voltage of the on-vehicle power supply 80 is detected, the control section 520 continues the ON state of the semiconductor power relay 154-1 to thereby start up the brushless DC motor 43. The threshold voltage Vth is about 60% of the rated supply voltage of the on-vehicle power supply 80.

In driving the semiconductor power relay (FET) 514-1, the control section 520 performs ON/OFF drive control via pulse-width modulation (PWM) using a voltage obtained between the connection node N2 between the power coil 111 and the semiconductor power relay (FET) 514-1 and the negative power line 102. More specifically, the control section 520 first repeats switching of the ON and OFF states of the semiconductor power relay (FET) 514-1 at a first duty ratio via the PWM for a first predetermined time period, then determines abnormality of the electrolytic capacitor 512 based on a voltage value Vc across the electrolytic capacitor 512 measured while the semiconductor power relay (FET) 514-1 is kept in the OFF state for a second predetermined time period. With this arrangement, the voltage value Vc across the electrolytic capacitor 512 can be checked without a separate pre-charging circuit, and a surge voltage resulting from a current supplied to the power coil 511 when the semiconductor power relay (FET) 514-1 is turned on by the PWM control can be suppressed.

When abnormality determination made by the control section 520 indicates that the electrolytic capacitor 512 is in an abnormal condition, the control section 520 sets the duty ratio to be smaller than before and also sets the drive period to be shorter than before to thereby suppress an overcurrent state of the semiconductor power relay (FET) 514-1.

The semiconductor driving circuit 521 performs, under the control of the control section 520) ON/OFF driving of the semiconductor switching elements (FETs) 510-1 to 510-6 of the three-phase bridge circuit 510, the semiconductor power relays 513-1 to 513-3, and the semiconductor power relays 514-1 and 514-2 based on predetermined duty ratios. As a consequence, a current is supplied from the semiconductor driving circuit 521 to the brushless DC motor 43 and the brushless DC motor 43 can generate an assist torque.

The ECU 50 for the electric power steering apparatus 10 will operates as follows. When the driver operates the steering wheel 21, a steering torque is applied to the steering shaft 22. The torque sensor 41 detects the steering torque and sends an output signal indicative of the detected steering torque to the control section 520. In this instance, the angular sensor 70 detects a rotational angle of the brushless DC motor 43 and sends an output signal indicative of the detected rotational angle to the control section 520. On the basis of the steering torque, the rotational angle, and a vehicle speed detected by the vehicle speed sensor 60, the control section 520 calculates an assist torque and controls the three-phase bridge circuit 510 to drive the brushless DC motor 43 in such a manner as to generates the calculated assist torque that can be applied to the steering shaft 22 via the torque transmission mechanism 44.

Based on an instruction received from the control section 520, the semiconductor driving circuit 521 generates a gate driving signal at a predetermined timing to control conduction of the semiconductor switching elements (FETs) 510-1 to 510-6 of the three-phase bridge circuit 510. Thus, the three-phase bridge circuit 510 generates predetermined three-phase electric power and supplies a three-phase alternating current to the stator winding of the brushless DC motor 43 to thereby drive the brushless DC motor 43. The torque generated by the brushless DC motor 43 is applied via the torque transmission mechanism 44 to the steering shaft 22 as an assist torque, so that a force required for the driver to operate the steering wheel 21 can be reduced.

The control section 520 performs phase compensation of the steering torque inputted from the torque sensor 41 and, based on the phase-compensated steering torque signal and a vehicle speed signal supplied from the vehicle speed sensor 60, the control sections 520 sets a target current signal indicative of a target assist current value to be supplied to the brushless DC motor 43. The target current signal is determined according to a target current map, which shows a relationship between the steering torque signal, the vehicle speed signal, and the target assist current value that are stored in advance. Then, the control section 520 subtracts a current signal detected by the shunt resistors R1, R2 and R3 from the set target current signal to thereby calculate a deviation current signal, and on the basis of the calculated deviation current signal, the control section 520 generates a PWM control signal for controlling the semiconductor driving current 521. The PWM control signal is a driving signal prepared for each of the semiconductor switching elements (FETs) 510-1 to 510-6 of the three-phase bridge circuit 510.

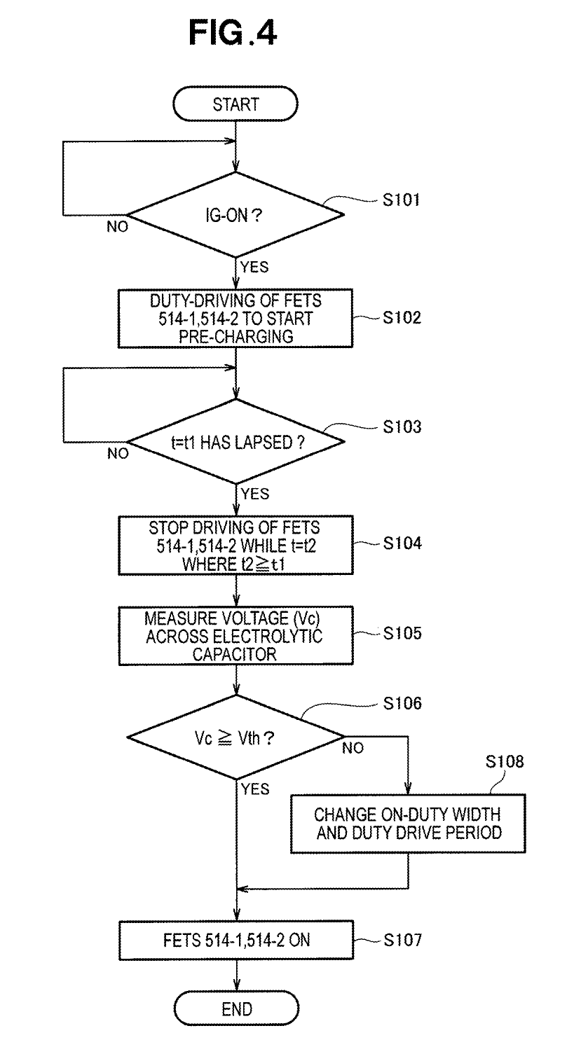

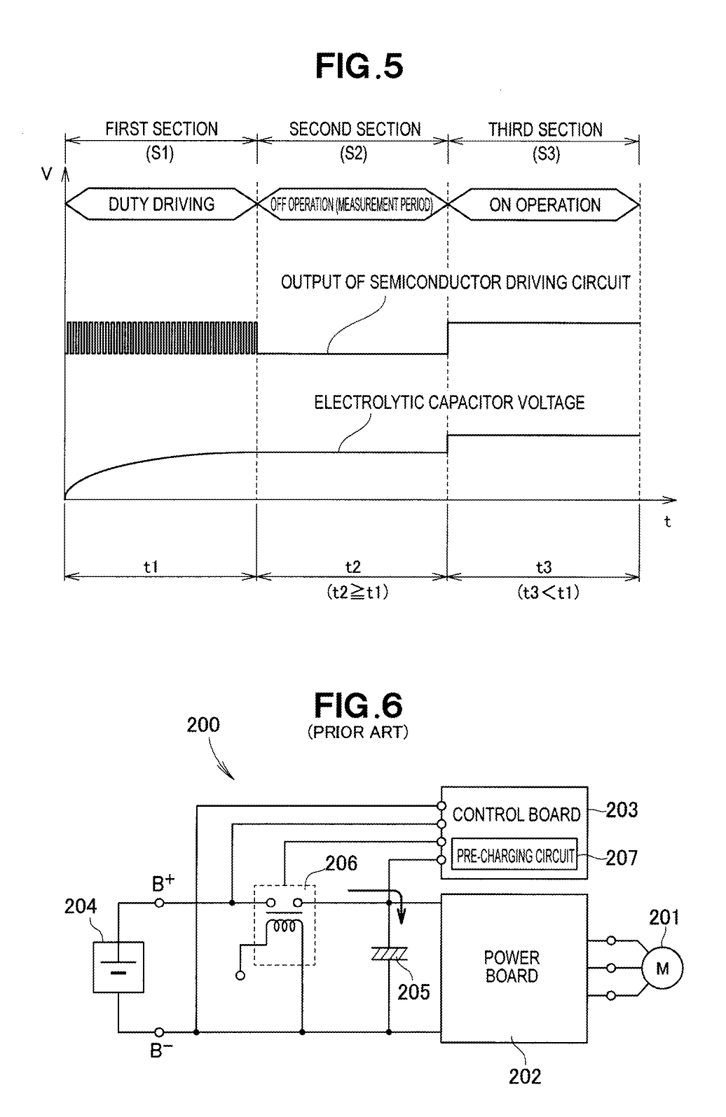

The ECU 50 for the EPS apparatus 10 according to the illustrated embodiment is configured to perform pre-charging of the electrolytic capacitor 512 via the same duty control as the PWM signal used for driving the semiconductor switching elements (FETs) 510-1 to 510-6 of the three-phase bridge circuit 510, so that the electrolytic capacitor 512 can be protected from an inrush current which may otherwise occur when the semiconductor power relay (FET) 514-1 is driven. Operation of the ECU 50 for the EPS apparatus 10 will be described in greater detail with reference to the flowchart shown in FIG. 4 and the timing chart shown in FIG. 5.

The control section 520 determines whether or not an ignition key is turned on at step S101. When the determination at step S101 is affirmative (i.e., “YES” determination), the control section 520 starts pre-charging of the electrolytic capacitor 512 via duty driving of the semiconductor power relay (FET) 514-1 at step S102. The pre-charging is undertaken by the semiconductor driving circuit 521 via PWM control by the control section 520. More specifically, the control section 520 controls the semiconductor driving circuit 521 such that at a first section S1 of the timing chart shown in FIG. 5, the semiconductor power relay (FET) 514-1 is driven in the frequency range of a few kHz to several tens of kHz, at a maximum duty ratio (ON-duty width) of hundreds μs, and for a first time period t1 (a few ms to several tens of ms).

When the time period t1 for the PWM duty driving has lapsed (“Yes” determination at step S103), the control section 520 keeps the semiconductor power relay (FET) 514-1 in the OFF state for a second time period t2 (a few ms to hundreds ins, where t2≧t1) and measures a voltage Vc across the electrolytic capacitor 512 (step S105 in FIG. 4), as achieved in a second section S2 of the time chart shown in FIG. 5. The control section 520 compares the measured voltage Vc across the electrolytic capacitor 512 with a threshold voltage Vth (step S106), where the threshold voltage Vth is set to be about 60% of a rated supply voltage of the on-vehicle power supply 80.

When Vc≧Vth (“YES” determination at step S106), the control section 520 controls the semiconductor driving circuit 521 in such a manner as to turn on the semiconductor power relay 514-1 in a third section S3 to thereby drive the brushless DC motor 43 (step S107). When Vc<Vth (“NO” determination at step S106), the electrolytic capacitor 512 is determined to be in an abnormal state. In this case, the control section 520 sets a duty ratio (ON-duty width) of the semiconductor power relay 514-1 to be smaller than the duty ratio used for duty driving at step S102 and also sets a duty-driving period (third time period) t3 to be shorter than the first time period t1 (step S108). By thus setting the duty ratio and duty-driving period, it is possible to suppress an overcurrent state of the semiconductor power relay (FET) 514-1, which will reduce an occurrence of ON-failure of the semiconductor power relay (FET) 514-1.

In the description given above with respect to the illustrated embodiment of the ECU 50 for the EPS apparatus 10, only the semiconductor power relay (FET) 514-1 which is provided for the purpose of cutting off or breaking the current flow has been explained. However, the foregoing operation can be also applied to the semiconductor power relay (FET) 514-2 provided for preventing reverse flow, in order to reduce an occurrence of ON failure. Furthermore, even when the semiconductor power relay (FET) 514-1 is replaced by a mechanical power relay, pre-charging of the electrolytic capacitor 512 can be achieved via the duty control discussed above.

Various advantageous effects attained by the ECU 50 for the EPS apparatus 10 according to the present invention are enumerated as follows.

(1) Pre-charging of the electrolytic capacitor 512, which is performed by switching ON and OFF states of a power relay 514 connected between the positive-electrode terminal of the on-vehicle power supply 80 and the positive power line 101, obviates the need for a separate pre-charging circuit and can reduce the cost and size of the ECU 50 irrespective of whether a mechanical power relay is used or a semiconductor power relay is used for cutting off the flow of current between the positive power line 101 and the negative power line 102.
(2) By virtue of the ON state of the power relay 514, which continues to start the brushless DC motor 43 only when a voltage value measured across the electrolytic capacitor 512 is equal to or higher than a predetermined threshold voltage set to be lower than the supply voltage of the on-vehicle power supply 80, abnormality of the electrolytic capacitor 512 can be detected without requiring a separate charging circuit.
(3) The semiconductor (FET) 514-1 used as a power relay is completely free from a problem which may occur in the case of a mechanical power relay due to fusion welding caused by an inrush current flowing into the electrolytic capacitor 512.
(4) The field-effect transistor (FET) 514-2, which has a different polarity from the field-effect transistor (FET) 514-1 and is connected in series with the field-effect transistor (FET) 514-1 to form a semiconductor power relay 514, can protect the field-effect transistor (FET) 514-1 and other components from short-circuiting that may occur when the electrolytic capacitor 512 can be achieved.
(5) Switching of the ON and OFF states of the semiconductor power relay (FET) 514-1 repeated at a predetermined duty ratio via PWM for a first predetermined time period, which is followed by a measurement cycle achieved to measure a voltage across the electrolytic capacitor 512 while the semiconductor power relay (FET) 514-1 is kept in the OFF state for a second predetermined time period, ensures that the voltage across the electrolytic capacitor 512 can be measured without a separate pre-charging circuit, and abnormality determination of the electrolytic capacitor 521 is possible to achieve.
(6) The ON/OFF drive control, which is performed via pulse-width modulation (PWM) using a voltage obtained between the connection node N2 between the power coil 511 and the drain terminal of the semiconductor power relay (FET) 514-1 and the negative power line 102, can suppress a surge voltage resulting from a current supplied to the power coil 511 when the semiconductor power relay (FET) 514-1 is turned on by the PWM control.
(7) Even when the electrolytic capacitor 512 is determined to be in an abnormal condition, the semiconductor power relay (FET) 514-1 is protected from an overcurrent state by setting the duty ratio to be smaller than before and also setting the drive period to be shorter than before.

Obviously, various minor changes and modifications of the present invention are possible in light of the above teaching. It is therefore to be understood that within the scope of the appended claims the invention may be practiced otherwise than as specifically described.

What is claimed is:

1. An electronic control device for an electric power steering apparatus, comprising:
a first line connected to a positive electrode of an on-vehicle power supply;
a second line connected to a negative electrode of the on-vehicle power supply;
a power relay connected between the positive electrode of the on-vehicle power supply and the first line;
a capacitive element connected between the first line and the second line; and
a control section configured to switch ON and OFF states of the power relay to thereby perform pre-charging of the capacitive element.

2. The electronic control device according to claim 1, wherein the control section measures a voltage across the capacitive element and, when a voltage value equal to or higher than a predetermined threshold voltage set to be lower than a supply voltage of the on-vehicle power supply is detected, the control section continues the ON state of the power relay to thereby start a motor of the electric power steering apparatus.

3. The electronic control device according to claim 1, further comprising:
a semiconductor driving circuit including a gate resistor; and
a power coil connected to the first line,
wherein the power relay comprises a semiconductor relay having a drain terminal connected to the power coil, the semiconductor relay being driven when a voltage equal to or higher than a predetermined threshold voltage set to be lower than a supply voltage of the on-vehicle power supply is applied via the gate resistor to the semiconductor relay.

4. The electronic control device according to claim 1, further comprising:
a semiconductor driving circuit including a gate resistor; and
a power coil connected to the first line,
wherein the power relay includes
a first semiconductor relay having a drain terminal connected to the power coil, the first semiconductor relay being driven when a voltage equal to or higher than a predetermined threshold voltage set to be lower than a supply voltage of the on-vehicle power supply is applied via the gate resistor to the first semiconductor relay, and
a second semiconductor relay having a source terminal connected in common with a source terminal of the first semiconductor relay and a drain terminal connected with a node located in the proximity of the capacitive element, and
wherein the control section performs ON/OFF drive control of the first semiconductor relay via pulse-width modulation using a voltage obtained between a connection node between the power coil and the drain terminal of the first semiconductor relay and the second line.

5. The electronic control device according to claim 3, wherein the control section drives the semiconductor relay in such a manner that switching of the ON and OFF states of the semiconductor relay is repeatedly performed at a first duty ratio via pulse-width modulation for a first predetermined time period, then abnormality of the capacitive element is determined on the basis of a voltage value measured across the capacitive element while the OFF state of the semiconductor relay is continued for a second time period equal to or longer than the first time period.

6. The electronic control device according to claim 5, wherein when the capacitive element is determined to be in an abnormal condition, the control section drives the semiconductor relay at a second duty ratio set to be smaller than the first duty ratio for a third time period shorter than the first time period.
